(19) United States
(12) Patent Application Publication
(10) Pub. No.: US 2020/0101406 A1
(43) Pub. Date: Apr. 2, 2020

(54) FLANGE MEMBER AND FLANGE FORMING METHOD

(71) Applicant: ROKI TECHNO CO., LTD., Tokyo (JP)

(72) Inventor: Osamu KUMAGAI, Tokyo (JP)

(21) Appl. No.: 16/621,228

(22) PCT Filed: Jun. 12, 2018
(86) PCT No.: PCT/JP2018/022320

§ 371 Date: Dec. 10, 2019

(30) Foreign Application Priority Data
Jun. 14, 2017 (JP) 2017-116908

(51) Int. Cl. B01D 29/27; B01D 29/11; B01D 35/30; B01D 46/24; B29C 57/10; F16B 5/08; B01D 46/00

(52) U.S. Cl. CPC B01D 29/27; B01D 29/111; B01D 35/30; B01D 2201/34; B29C 57/10; F16B 5/08; B01D 46/0004; B01D 46/2414

(57) ABSTRACT

A structure in which no shearing force acts on each member is desired to be used at a welded part where a stress is liable to be concentrated. To solve this problem, the flange member includes a cap member, a ring member, and sheet-shaped thermoplastic resin member. At least one end of the thermoplastic resin member includes a protruding part that protrudes from an end surface of the cap member and from an end surface of the ring member. The protruding part is welded to the end surface of the cap member and to the end surface of the ring member.

### TECHNICAL FIELD

The present invention relates to a flange member and a flange member forming method. In particular, the present invention relates to a flange member for a filter member or a filter container for storing a filter member, and a flange member forming method.

### BACKGROUND ART

In some cases, a thin member, such as a non-woven fabric used for a filter member or the like, or a laminate sheet used for a container outer member needs to be formed in a tubular shape to seal openings at both ends of the thin member with end caps or the like.

### SUMMARY OF INVENTION

### Technical Problem

In such cases, as illustrated in FIG. 11, on a side surface 61a of an end cap 61, a thin sheet member 62, such as a non-woven fabric or a laminate sheet, can be welded. However, when the thin sheet member 62 is used, in a mode in which the side surface of the end cap 61 is welded, a central portion of the thin sheet member 62 expands due to an inner pressure P and the diameter of the central portion increases. On the other hand, the diameter of a welded part 63 of the end cap 61 does not change. This leads to a problem that a stress is concentrated on the welded part 63 and the thin sheet member 62 is damaged due to a shearing force in the vicinity of the welded part.

Accordingly, a structure in which no shearing force acts on each member is desirably used at the welded part 63 where a stress is liable to be concentrated.

### Solution to Problem

To solve the above-described problem, provided is a flange member including a thermoplastic resin-made cap member including an end surface and an outer peripheral surface; a thermoplastic resin-made ring member including an end surface and an inner peripheral surface opposed to the outer peripheral surface of the cap member; and a sheet-shaped thermoplastic resin member formed in a hollow shape with an opening in at least one end. The thermoplastic resin member is nipped between the outer peripheral surface of the cap member and the inner peripheral surface of the ring member such that an inner surface of the thermoplastic resin member located near the opening comes into contact with the outer peripheral surface of the cap member and an outer surface of the thermoplastic resin member comes into contact with the inner peripheral surface of the ring member, the at least one end of the thermoplastic resin member including a protruding part that protrudes from the end surface of the cap member and from the end surface of the ring member. The protruding part is welded to the end surface of the cap member and to the end surface of the ring member.

To solve the above-described problem, provided is a flange member including: a thermoplastic resin-made cap member including an end surface and an outer peripheral surface; a thermoplastic resin-made ring member including an end surface and an inner peripheral surface opposed to the outer peripheral surface of the cap member; a sheet member formed in a hollow shape with an opening in at least one end; and a thermoplastic resin member that nips the sheet member. The thermoplastic resin member is nipped between the outer peripheral surface of the cap member and the inner peripheral surface of the ring member such that an inner surface of the thermoplastic resin member located near the opening comes into contact with the outer peripheral surface of the cap member and an outer surface of the thermoplastic resin member comes into contact with the inner peripheral surface of the ring member, the at least one end of the thermoplastic resin member including a protruding part that protrudes from the end surface of the cap member and from the end surface of the ring member. The protruding part is welded to the end surface of the cap member and to the end surface of the ring member.

To solve the above-described problem, provided is a filter member including: a non-woven fabric formed in a hollow shape with an opening in at least one end; a thermoplastic resin-made cap member including an end surface and an outer peripheral surface; and a thermoplastic resin-made ring member including an end surface and an inner peripheral surface opposed to the outer peripheral surface of the cap member. The non-woven fabric is nipped between the outer peripheral surface of the cap member and the inner peripheral surface of the ring member such that an inner surface of the non-woven fabric located near the opening comes into contact with the outer peripheral surface of the cap member and an outer surface of the non-woven fabric comes into contact with the inner peripheral surface of the ring member, the at least one end of the non-woven fabric including a protruding part that protrudes from the end surface of the cap member and from the end surface of the ring member. The protruding part is welded to the end surface of the cap member and to the end surface of the ring member.

To solve the above-described problem, provided is a filter container including: a laminate member formed in a hollow shape with an opening in at least one end; a thermoplastic resin-made cap member including an end surface and an outer peripheral surface; and a thermoplastic resin-made ring member including an end surface and an inner peripheral surface opposed to the outer peripheral surface of the cap member. The laminate member is nipped between the outer peripheral surface of the cap member and the inner peripheral surface of the ring member such that an inner surface of the laminate member located near the opening comes into contact with the outer peripheral surface of the cap member and an outer surface of the laminate member comes into contact with the inner peripheral surface of the ring member, the at least one end of the laminate member including a protruding part that protrudes from the end surface of the cap member and from the end surface of the ring member. The protruding part is welded to the end surface of the cap member and to the end surface of the ring member.

To solve the above-described problem, provided is a flange member forming method including the steps of: nipping a sheet-shaped thermoplastic resin member between a thermoplastic resin-made cap member including an end surface and an outer peripheral surface and a thermoplastic resin-made ring member including an end surface and an inner peripheral surface opposed to the outer peripheral surface of the cap member, the thermoplastic resin member being formed in a hollow shape with an opening in at least one end, the thermoplastic resin member being nipped between the outer peripheral surface of the cap member and the inner peripheral surface of the ring member such that an inner surface of the thermoplastic resin member located near the opening is brought into contact with the outer peripheral surface of the cap member and an outer surface of the thermoplastic resin member is brought into contact with the inner peripheral surface of the ring member, the at least one end of the thermoplastic resin member including a protruding part that protrudes from the end surface of the cap member and from the end surface of the ring member; and welding the protruding part to the end surface of the cap member and to the end surface of the ring member.

To solve the above-described problem, provided is a flange forming method including: nipping, by a thermoplastic resin member, a sheet member formed in a hollow shape with an opening in at least one end to nip the thermoplastic resin member between a thermoplastic resin-made cap member including an end surface and an outer peripheral surface and a thermoplastic resin-made ring member including an end surface and an inner peripheral surface opposed to the outer peripheral surface of the cap member, the thermoplastic resin member being nipped between the outer peripheral surface of the cap member and the inner peripheral surface of the ring member such that an inner surface of the thermoplastic resin member located near the opening is brought into contact with the outer peripheral surface of the cap member and an outer surface of the thermoplastic resin member is brought into contact with the inner peripheral surface of the ring member, the at least one end of the thermoplastic resin member including a protruding part that protrudes from the end surface of the cap member and from the end surface of the ring member; and welding the protruding part to the end surface of the cap member and to the end surface of the ring member.

### Advantageous Effects of Invention

According to the present invention, it is possible to cause a filtered fluid to flow through a welded part of a filter member.

### BRIEF DESCRIPTION OF DRAWINGS

FIG. 1 is a view illustrating a filter member to which a flange member according to Embodiment 1 of the present invention is applied.

FIG. 2 is an enlarged view illustrating a flange part according to Embodiment 1 of the present invention.

FIG. 3A is an exploded view illustrating the flange part according to Embodiment 1 of the present invention.

FIG. 3B is a sectional view illustrating the flange part according to Embodiment 1 of the present invention before a filter material is welded.

FIG. 3C is a sectional view illustrating the flange part according to Embodiment 1 of the present invention after the filter material is welded.

FIG. 4A is an exploded view illustrating a flange part according to Embodiment 2 of the present invention.

FIG. 4B is a sectional view illustrating the flange part according to Embodiment 2 of the present invention before the filter material is welded in a shape in which a gap between a cap member and a ring member is inclined.

FIG. 4C is a sectional view illustrating the flange part according to Embodiment 2 of the present invention after the filter material is welded in a shape in which the gap between the cap member and the ring member is inclined.

FIG. 5 is a view illustrating another filter member to which the flange member according to Embodiment 1 or 2 of the present invention is applied.

FIG. 6 is a view illustrating a filter container according to Embodiment 3 of the present invention.

FIG. 7 is a view illustrating the filter container according to Embodiment 3 of the present invention.

FIG. 8 is a view illustrating the filter container according to Embodiment 3 of the present invention.

FIG. 9 is an exploded view illustrating a flange part according to Embodiment 4 of the present invention.

FIG. 10A is a sectional view illustrating the flange part according to Embodiment 4 of the present invention before a filter material is welded.

FIG. 10B is a sectional view illustrating the flange part according to Embodiment 4 of the present invention after the filter material is welded.

FIG. 11 is a view illustrating a mode in which a related-art filter material is welded.

### DESCRIPTION OF EMBODIMENTS

### Embodiment 1

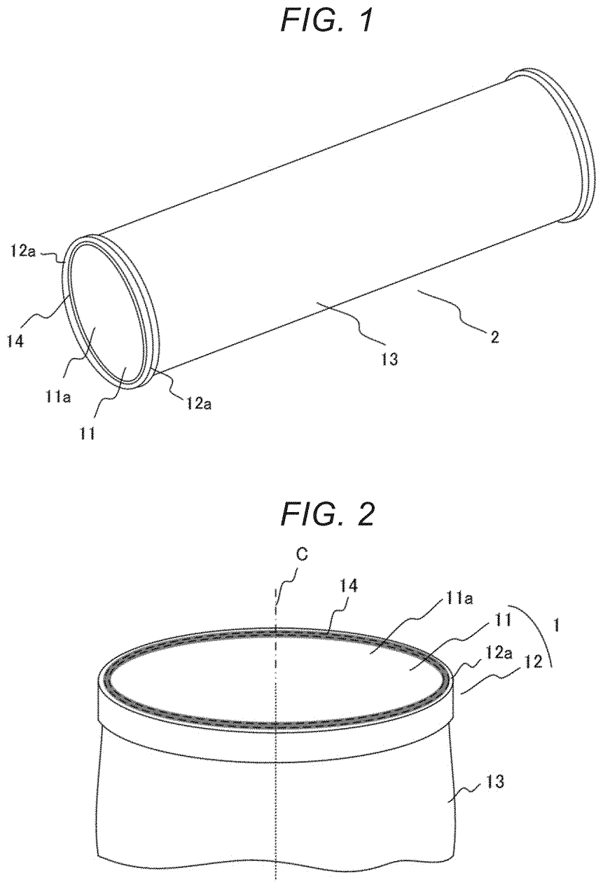

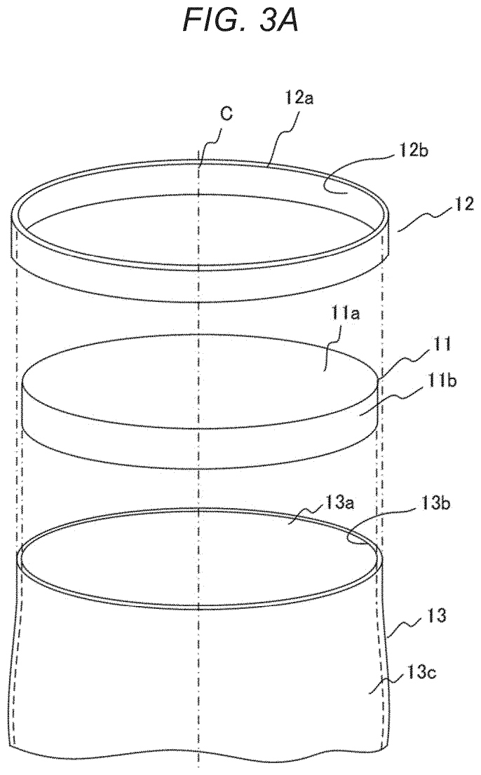

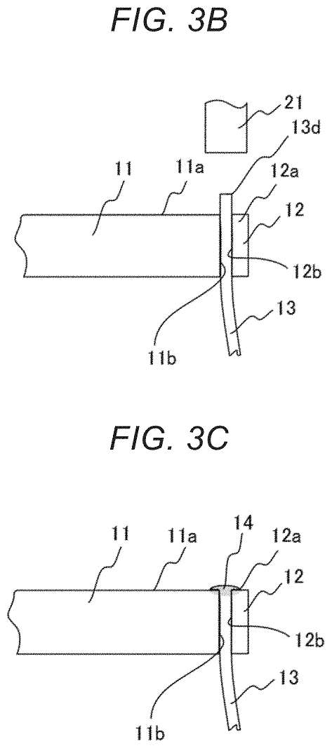

The present invention will be described with reference to FIGS. 1 to 3C. FIG. 1 is a view illustrating a filter member 2 to which a flange member 1 according to Embodiment 1 of the present invention is applied. FIG. 2 is an enlarged view illustrating an area in the vicinity of the flange member 1. FIG. 3A is an exploded view of the filter member 2 illustrated in FIG. 2. FIGS. 3B and 3C sequentially illustrate production processes for the flange member 1 according to Embodiment 1. The flange member 1 typically corresponds to the flange member 1 of the filter member 2, or corresponds to a flange member for a filter container that stores the filter member 2. The filter member 2 will now be described as an example.

The filter member 2 to which the flange member 1 is applied includes the flange member 1 and a filter material 13. The flange member 1 includes a cap member 11 and a ring member 12. The cap member 11 and the ring member 12 are each made of a thermoplastic resin. The filter material 13 is nipped between the cap member 11 and the ring member 12, and an end of the filter material 13 is welded such that the end straddles over an end surface 11a of the cap member 11 and an end surface 12a of the ring member 12, and forms a welded part 14.

The filter material 13 is typically a non-woven fabric made of thermoplastic resin-made fibers. The non-woven fabric is formed in a cylindrical shape. The filter material 13 need not necessarily have a circular section. The filter material 13 includes an opening 13a in at least one end thereof. The cap member 11 is disposed to be fit into the opening 13a of the filter material 13. The cap member 11 is positioned relatively to the filter material 13 such that an outer peripheral side surface 11b of the cap member 11 comes into contact with an inner surface 13b of the filter material 13. The ring member 12 is disposed outside the opening 13a of the filter material 13 such that the filter material 13 is nipped between the ring member 12 and the cap member 11. The ring member 12 is positioned relatively to the filter material 13 such that an inner peripheral surface 12b of the ring member 12 comes into contact with an outer surface 13b of the filter material 13. The order of nipping the filter material 13 can be arbitrarily set by combining the cap member 11 and the ring member 12.

The cap member 11 and the ring member 12 which constitute the flange member 1 are assembled such that the outer peripheral side of the cap member 11 faces the inner peripheral side of the ring member 12. At this time, the outer diameter of the cap member 11 and the inner diameter of the ring member 12 are selected in consideration of the thickness of the filter material 13 so that the filter material 13 can be nipped between the cap member 11 and the ring member 12. Specifically, a gap to be formed depending on the thickness of the filter material 13 is theoretically generated between the outer diameter of the cap member 11 and the inner diameter of the ring member 12. By adjusting the dimensions of this gap, the degree of fixation among the cap member 11, the ring member 12, and the filter material 13 can be adjusted. In a state where the filter material 13 is nipped between the cap member 11 and the ring member 12, a dimensional relationship in which the cap member 11 and the ring member 12 are substantially fixed may be desirable. At this time, the shape and dimensions of the gap can be arbitrarily changed. That is, typically, the gap between the outer peripheral side surface 11b of the cap member 11 and the inner peripheral surface 12b of the ring member 12 can be set in a columnar shape, which extends along a direction of an axis C of the hollow cylinder of the filter material 13, such that the cap member 11 has a cylindrical shape and the ring member 12 has a surface that is substantially parallel to the outer peripheral side surface 11b of the cap member 11.

The height of the end surface 11a of the cap member 11 is set to be substantially the same as the height of the end surface 12a of the ring member 12. The difference between the heights may be desirably as small as possible. Ideally, the end surface 11a of the cap member 11 and the end surface 12a of the ring member 12 can be formed on substantially the same virtual plane, i.e., the so-called plane position of the end surface 11a of the cap member 11 matches that of the end surface 12a of the ring member 12, but a step may be generated. The heights are not particularly limited, as long as welding can be performed such that a protruding part 13d straddles over the end surface 11a of the cap member 11 and the end surface 12a of the ring member 12.

In the case of nipping the filter material 13 between the cap member 11 and the ring member 12, the positions of the cap member 11, the ring member 12, and the filter material 13 are determined such that an end of the filter material 13 that is located closer to the opening 13a includes the protruding part 13d that protrudes from a surface formed by the end surface 11a of the cap member 11 and the end surface 12a of the ring member 12. The protruding part 13d is welded to the end surface 11a of the cap member 11 and to the end surface 12a of the ring member 12, while the protruding part 13d is pressed by a welding head 21 of a welding machine. The protruding part 13d is formed as the welded part 14 that is fixed such that the protruding part 13d straddles over the end surface 11a of the cap member 11 and the end surface 12a of the ring member 12. Thus, since the welded part 14 is formed in a material axial direction of the filter material 13, even when a load acts on the filter material 13, the welded part 14 is formed in a direction in which the filter material 13 extends, and thus no rapture force acts on the filter material 13.

The filter material 13 need not necessarily have a cylindrical shape. As illustrated in FIG. 5, a filter material 13e having a folded-up shape may be used. In addition, each of the cap member 11 and the ring member 12 need not necessarily have a circular outer shape.

### Embodiment 2

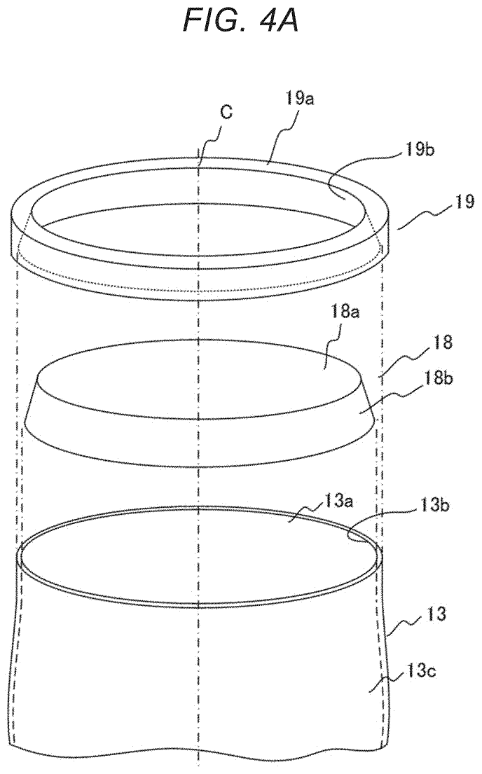

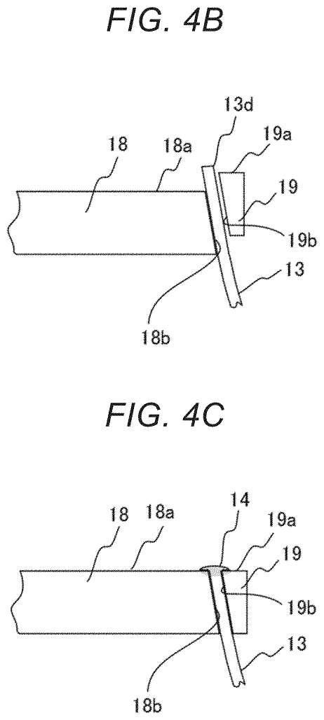

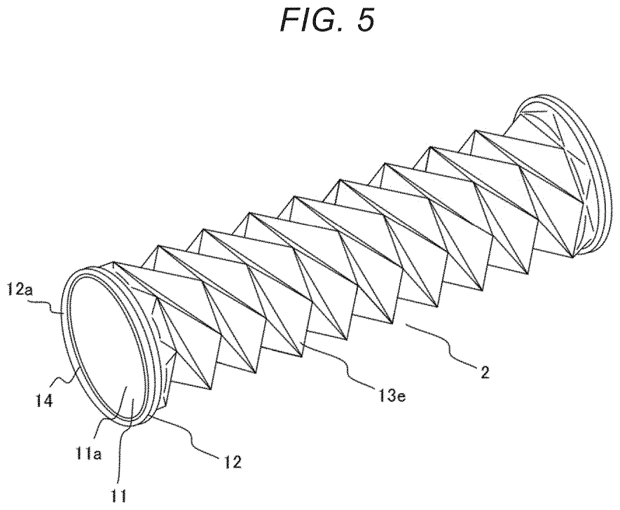

In Embodiment 1, the gap between the outer peripheral side surface 11b of the cap member 11 and the inner peripheral surface 12b of the ring member 12 is set such that the gap extends substantially in parallel with the direction of the axis C of the hollow cylinder of the filter material 13 in section. On the other hand, in Embodiment 2, a gap between an outer peripheral side surface 18b of a cap member 18 and an inner peripheral surface 19b of a ring member 19 has a tapered shape in section, i.e., the gap is set to be inclined along the direction of the axis C of the hollow cylinder of the filter material 13. FIGS. 4A, 4B, and 4C according to Embodiment 2 respectively correspond to FIGS. 3A to 3C according to Embodiment 1. FIGS. 4B and 4C each illustrate an example of Embodiment 2 in which the gap between the outer peripheral side surface 18b of the cap member 18 and the inner peripheral surface 19b of the ring member 19 has a tapered shape in section. FIG. 4B illustrates a state before assembly. FIG. 4C illustrates a state after assembly. The cap member 18 has a truncated conical shape in which the side surface 18b is an inclined surface. Further, the inner peripheral surface 19b of the ring member 19 is an inclined surface with an angle that is substantially parallel to the side surface 18b of the cap member 18. The gap between the outer peripheral side surface 18b of the cap member 18 and the inner peripheral surface 19b of the ring member 19 extends such that the gap is inclined along the axis direction (direction of the axis C of the hollow cylinder of the filter material 13) of the truncated cone.

In Embodiment 2, the members can be assembled in the order illustrated in FIGS. 4B and 4C. First, the filter material 13 is attached to the cap member 18 such that the inner surface 13b of the opening 13a of the hollow cylinder of the filter material 13 comes into contact with the outer peripheral side surface 18b of the cap member 18 (FIG. 4B). In this case, like in Embodiment 1, the opening 13a of the hollow cylinder of the filter material 13 forms the protruding part 13d. In this state, the ring member 19 is fit into the cap member 18 by bringing the inner peripheral surface 19b of the ring member 19 into press contact with the outer peripheral surface in the vicinity of the opening 13a of the filter material 13. Further, like in Embodiment 1, the protruding part 13d is fixed and welded such that the protruding part 13d straddles over the end surface 18a of the cap member 18 and the end surface 19a of the ring member 19, and the protruding part 13d is formed as the welded part 14. Thus, the filter material 13 can be easily nipped in the gap between the outer peripheral side surface 18b of the cap member 18 and the inner peripheral surface 19b of the ring member 19, and the filter material 13 can be easily fixed in a state where the filter material 13 is nipped between the cap member 18 and the ring member 19.

### Embodiment 3

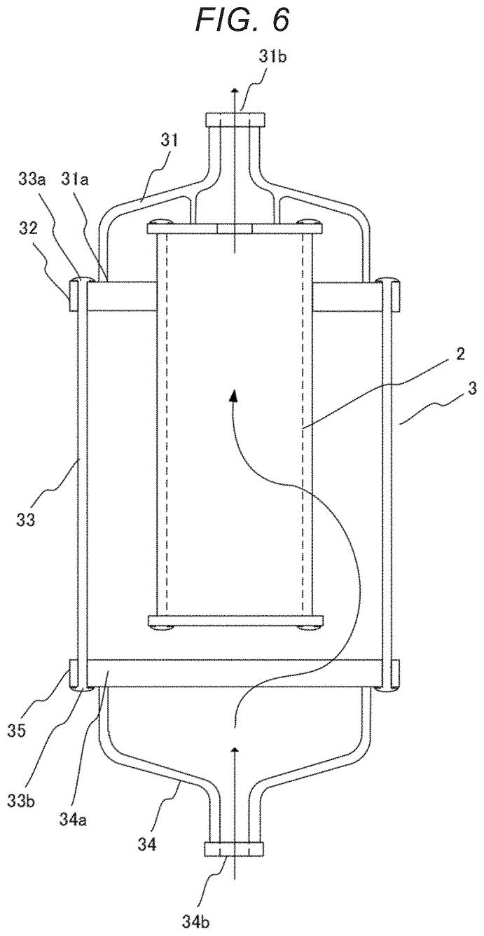

Next, Embodiment 3 of the present invention will be described with reference to FIGS. 6 to 8. Embodiment 1 is described above as the flange member 1 of the filter member 2. Specifically, Embodiment 1 illustrates an example in which each of the cap member 11, the ring member 12, and the filter material 13 is made of a thermoplastic resin. However, instead of using the filter material 13, such as the non-woven fabric used in Embodiment 1, a laminate sheet made of a thermoplastic resin can also be used. Specifically, Embodiment 2 illustrates an example in which a laminate sheet made of a thermoplastic resin is used instead of the filter material 13 and the flange member 1 for a filter container 3 is formed as an outer member that stores the filter member. Examples of the thermoplastic resin used as the material for the laminate sheet include an ethylene-vinylalcohol copolymer, a polyolefin resin such as polyethylene or polypropylene, a fluorinated resin such as polytetrafluoroethylene, a tetrafluoroethylene-perfluoroalkyl vinyl ether copolymer, a tetrafluoroethylene-hexafluoropropylene copolymer, a tetrafluoroethylene-ethylene copolymer, a polyvinylidene fluoride, a poly chloro tri fluoro ethylene, or a chloro tri fluoro ethylene polymer, a polyester such as polyethylene terephthalate, acrylic resin such as poly(methyl methacrylate), polysulfone, polyether sulfone, polyphenyl ether sulfone, polyphenylene sulfide, polyacetal, polyvinyl alcohol, polystyrene, polycarbonate, and polyamide.

FIGS. 6 to 8 illustrate sections of the filter container 3, a filter container 4, and a filter container 5, respectively, to which Embodiment 3 of the present invention is applied. In examples illustrated in FIGS. 6 to 8, the filter container 3, the filter container 4, and the filter container 5 store the filter member 2 according to Embodiment 1 of the present invention. However, not only the filter member 2 according to Embodiment 1, but also a general filter member may be stored. In addition, a storage container that does not store the filter member 2 may also be used.

Embodiment 3 is similar to Embodiment 1, except that a laminate sheet made of a thermoplastic resin is used as the filter material 13 according to Embodiment 1. Specifically, in the case of the filter container 3 illustrated in FIG. 6, the flange member 1 includes a cap 31a of a frame 31 including an outlet port 31b and a ring member 32, which are disposed at one end, and a cap 34a of a frame 34 including an inlet port 34b and a ring member 35, which are disposed at an opposite end. The cap 31a, the ring member 32, and a laminate sheet 33 may be formed corresponding to the cap member 11, the ring member 12, and the filter material 13, respectively, of Embodiment 1, and Embodiment 1 may be applied to each of the cap 31a, the ring member 32, and the laminate sheet 33. Specifically, at one end, the laminate sheet 33 is nipped between the cap 31a and the ring member 32 such that a protruding part is formed on the laminate sheet 33, and the protruding part is welded so as to straddle over the surface of the cap 31a and the surface of the ring member 32, thereby forming a welded part 33a. At an opposite end, the cap 34a, the ring member 35, and the laminate sheet 33 may be formed corresponding to the cap member 11, the ring member 12, and the filter material 13, respectively, of Embodiment 1, and Embodiment 1 may be applied to each of the cap 34a, the ring member 35, and the laminate sheet 33. Specifically, the laminate sheet 33 is nipped between the cap 34a and the ring member 35 such that a protruding part is formed on the laminate sheet 33, and the protruding part is welded so as to straddle over the surface of the cap 34a and the surface of the ring member 35, thereby forming a welded part 33b. Thus, a container using the frame 31, the frame 34, and the laminate sheet 33 as an outer member can be formed. When the filter member 2 is stored in the container, the filter container 3 can be obtained. Since the outer member is formed of a laminate sheet, a flexible outer member can be formed.

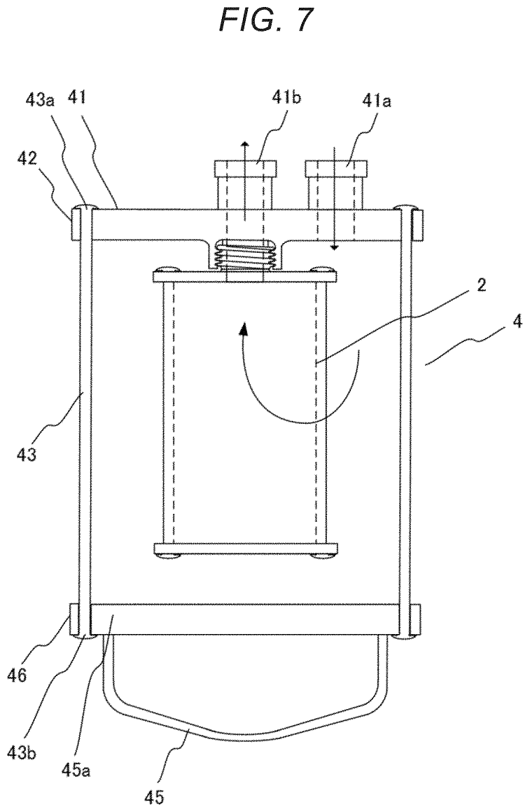

The same holds true for the filter container 4 illustrated in FIG. 7. The filter container 4 illustrated in FIG. 7 includes an inlet port 41 and an outlet port 41b that are formed in one end of the filter container 4. In this case, a cap 41 including the inlet port 41 and the outlet port 41b and a ring member 42 are disposed at one end, and a frame 45 including a cap 45a and a ring member 46 are disposed at an opposite end. Further, a mode in which a laminate sheet 43 is nipped between the cap 41 and the ring member 42 at one end and the laminate sheet 43 is nipped between the cap 45a and the ring member 46 at an opposite end is employed. The cap 41, the ring member 42, and the laminate sheet 43 may be formed corresponding to the cap member 11, the ring member 12, and the filter material 13, respectively, of Embodiment 1, and Embodiment 1 may be applied to each of the cap 41, the ring member 42, and the laminate sheet 43. Specifically, the laminate sheet 43 is nipped between the cap 41 and the ring member 42 such that a protruding part is formed on the laminate sheet 43, and the protruding part is welded so as to straddle over the surface of the cap 41 and the surface of the ring member 42, thereby forming a welded part 43a. At an opposite end, the cap 45a, the ring member 46, and the laminate sheet 43 may be formed corresponding to the cap member 11, the ring member 12, and the filter material 13, respectively, of Embodiment 1, and Embodiment 1 may be applied to each of the cap 45a, the ring member 46, and the laminate sheet 43. Specifically, the laminate sheet 43 is nipped between the cap 45a and the ring member 46 such that a protruding part is formed on the laminate sheet 43, and the protruding part is welded so as to straddle over the surface of the cap 45a and the surface of the ring member 46, thereby forming the welded part 43a. Also, in this mode, the outer member is formed of a laminate sheet, and thus a flexible outer member can be formed.

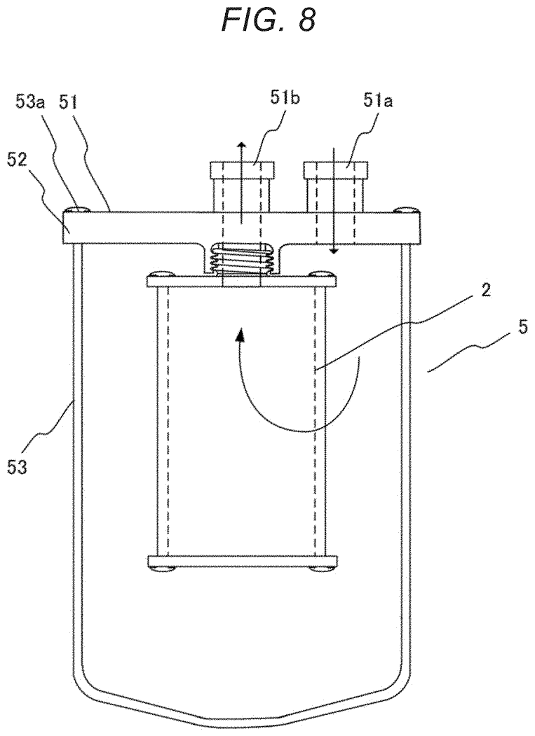

The same holds true for the filter container 5 illustrated in FIG. 8. In the filter container 5 illustrated in FIG. 8, a laminate sheet 53 has a bag shape and an opening of the laminate sheet 53 is sealed with a cap 51 including an inlet port 51a and an outlet port 51b. Specifically, the flange member 1 of the filter container 5 illustrated in FIG. 8 includes the cap 51 and a ring member 52. The cap 51, the ring member 52, and the laminate sheet 53 may be formed corresponding to the cap member 11, the ring member 12, and the filter material 13, respectively, of Embodiment 1, and Embodiment 1 may be applied to each of the cap 51, the ring member 52, and the laminate sheet 53. Specifically, the laminate sheet 53 is nipped between the cap 51 and the ring member 52 such that a protruding part is formed on the laminate sheet 53, and the protruding part is welded so as to straddle over the surface of the cap 51 and the surface of the ring member 52, thereby forming a welded part 53a. Also, in this mode, the outer member is formed of a laminate sheet, and thus a flexible outer member can be formed.

### Embodiment 4

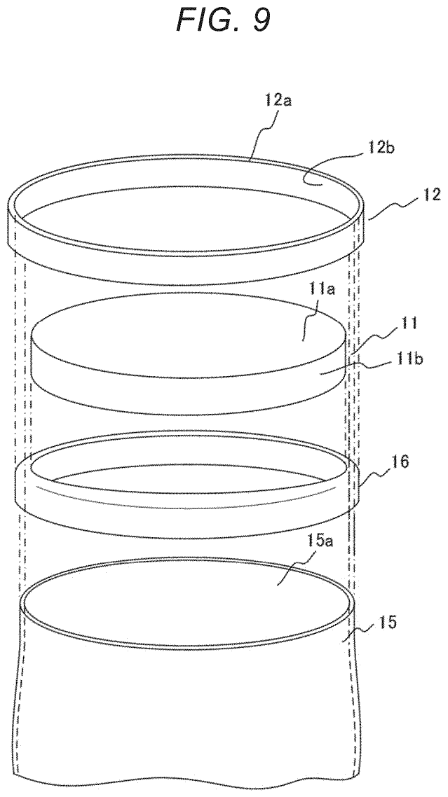

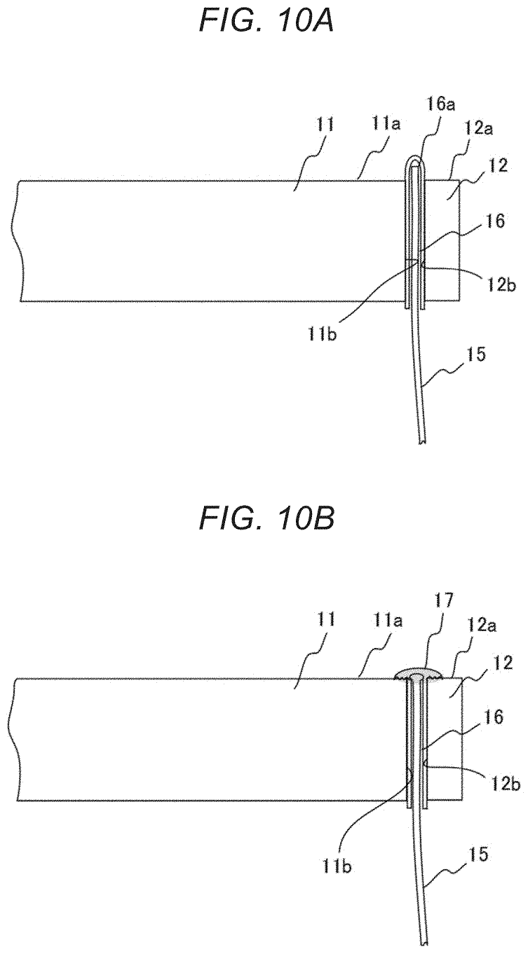

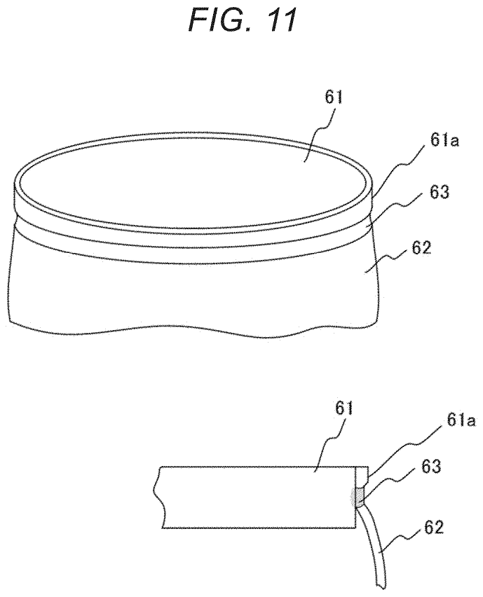

Next, Embodiment 4 will be described with reference to FIGS. 9 to 10B. In the case of Embodiment 2, a material that inhibits welding on a thermoplastic resin may be contained when, for example, metal is deposited on the surface of a laminate sheet. Embodiment 4 illustrates a case where a different material is contained in the laminate sheet or the like. FIG. 9 is an exploded view illustrating a flange member according to Embodiment 4, and corresponds to FIG. 3A according to Embodiment 1. FIGS. 10A and 10B each illustrate that a welded part is formed. Also, in Embodiment 4, like in Embodiment 1, the flange member 1 includes the cap member 11 and the ring member 12, and the cap member 11 and the ring member 12 are each made of a thermoplastic resin.

Unlike in Embodiment 1, at a location where a laminate sheet 15 comes into contact with the outer peripheral side surface 11b of the cap member 11 and with the inner peripheral surface 12b of the ring member 12, the both surfaces of the laminate sheet 15 are nipped by a thermoplastic resin-made cover sheet 16. The laminate sheet 15 nipped by the cover sheet 16 is nipped between the cap member 11 and the ring member 12, and an end of the laminate sheet 15 is welded such that the end straddles over the end surface 11a of the cap member 11 and the end surface 12a of the ring member 12, thereby forming a welded part 17.

The cover sheet 16 uses a thermoplastic resin, like the material for the laminate sheet according to Embodiment 2. The laminate sheet 15 includes an opening 15a in at least one end thereof. The cover sheet 16 nips the inner and outer surfaces of the laminate sheet 15 such that, for example, an end of the laminate sheet 15 is covered. The other features of Embodiment 4 can be achieved by applying Embodiment 1 to each of the cap member 11, the ring member 12, and the cover sheet 16 in a state where the filter material 13 according to Embodiment 1 is formed corresponding to the cover sheet 16 that nips the inner and outer surfaces of the laminate sheet 15. The cap member 11 and the ring member 12 are assembled to nip the cover sheet 16 so that the end surface 11a of the cap member 11 and the end surface 12a of the ring member 12 can be formed on the same virtual plane, i.e., the so-called plane position of the end surface 11a of the cap member 11 matches that of the end surface 12a of the ring member 12.

In a case where the cover sheet 16 is nipped by the cap member 11 and the ring member 12, the positions of the cap member 11, the ring member 12, and the cover sheet 16 are determined such that the cover sheet 16 includes a protruding part 16a that protrudes from a surface formed by the end surface 11a of the cap member 11 and the end surface 12a of the ring member 12. Further, the protruding part 16a is welded to the end surface 11a of the cap member 11 and to the end surface 12a of the ring member 12, while the protruding part 16a is pressed. The protruding part 16a is formed as the welded part 17 and is fixed such that the protruding part 16a straddles over the end surface 11a of the cap member 11 and the end surface 12a of the ring member 12.

This application is based upon and claims the benefit of priority from Japanese patent application No. 2017-116908, filed on Jun. 14, 2017, the disclosure of which is incorporated herein in its entirety by reference.

### REFERENCE SIGNS LIST

1 flange member
11 cap member
12 ring member
2 filter member
3, 4, 5 filter container
13 filter material
14, 17 welded part

1. A flange member, comprising:
a thermoplastic resin-made cap member including an end surface and an outer peripheral surface;
a thermoplastic resin-made ring member including an end surface and an inner peripheral surface opposed to the outer peripheral surface of the cap member; and
a sheet-shaped thermoplastic resin member formed in a hollow shape with an opening in at least one end,
wherein the thermoplastic resin member includes a nip portion nipped between the outer peripheral surface of the cap member and the inner peripheral surface of the ring member such that an inner surface of the thermoplastic resin member located near the opening comes into contact with the outer peripheral surface of the cap member and an outer surface of the thermoplastic resin member comes into contact with the inner peripheral surface of the ring member, the at least one end of the thermoplastic resin member including a protruding part that extends from the nip portion and protrudes from the end surface of the cap member and from the end surface of the ring member, and
wherein the protruding part is welded to the end surface of the cap member and to the end surface of the ring member.

2. The flange member according to claim 1, wherein the sheet-shaped thermoplastic resin member is a filter member made of a non-woven fabric.

3. The flange member according to claim 1, wherein the sheet-shaped thermoplastic resin member is a laminate film, and the flange member is used for a filter container using the laminate film as an outer member.

4-6. (canceled)

7. A filter member comprising the flange member according to claim 1 at an edge of the filter member,
wherein the non-woven fabric functions as the filter member.

8. A filter container comprising the flange member according to claim 1 at the filter container,
wherein the laminate member functions as an outer member of the filter container.

9. A method for forming a flange, comprising:
nipping a sheet-shaped thermoplastic resin member between a thermoplastic resin-made cap member including an end surface and an outer peripheral surface and a thermoplastic resin-made ring member including an end surface and an inner peripheral surface opposed to the outer peripheral surface of the cap member, the thermoplastic resin member being formed in a hollow shape with an opening in at least one end, the thermoplastic resin member being nipped between the outer peripheral surface of the cap member and the inner peripheral surface of the ring member such that an inner surface of the thermoplastic resin member located near the opening is brought into contact with the outer peripheral surface of the cap member and an outer surface of the thermoplastic resin member is brought into contact with the inner peripheral surface of the ring member, the at least one end of the thermoplastic resin member including a protruding part that protrudes from the end surface of the cap member and from the end surface of the ring member; and
welding the protruding part to the end surface of the cap member and to the end surface of the ring member.

10. The method according to claim 9, wherein the sheet-shaped thermoplastic resin member is a filter member made of a non-woven fabric.

11. The method according to claim 9, wherein the sheet-shaped thermoplastic resin member is a laminate film, and the flange forming method is used for a filter container using the laminate film as an outer member.

12-14. (canceled)

15. The flange member according to claim 1, wherein the protruding part includes another thermoplastic resin member to nip outer and inner surfaces of the sheet-shaped thermoplastic resin member to lap the protruding part.

16. The flange member according to claim 15, wherein the sheet-shaped thermoplastic resin member is a filter member made of a non-woven fabric.

17. The flange member according to claim 15, wherein the sheet-shaped thermoplastic resin member is a laminate film, and the flange member is used for a filter container using the laminate film as an outer member.

18. The method according to claim 9, wherein nipping the sheet-shaped thermoplastic resin member includes lapping the protruding part by nipping inner and outer surfaces of the sheet-shaped thermoplastic resin member with another thermoplastic resin member to form the protruding part.

19. The method according to claim 18, wherein the sheet-shaped thermoplastic resin member is a filter member made of a non-woven fabric.

20. The method according to claim 18, wherein the sheet-shaped thermoplastic resin member is a laminate film, and the flange forming method is used for a filter container using the laminate film as an outer member.
